(19) United States
(12) Patent Application Publication
(10) Pub. No.: US 2005/0010457 A1
(43) Pub. Date: Jan. 13, 2005

(54) Automated offer-based negotiation system and method

(76) Inventor: Richard W. Ettinger JR., New Canaan, CT (US)

Correspondence Address: McCarter & English, LLP;Attn: Anita Lomartra, CityPlace I, 36 Floor, 185 Asylum Street, Hartford, CT, 06103-3495, US

(21) Appl. No.: 10/831,947

(22) Filed: Apr. 26, 2004

Related U.S. Application Data
(63) Continuation-in-part of application No. 10/616,878, filed on Jul. 10, 2003.

(51) Int. Cl. G06F 17/60

(52) U.S. Cl. 705/7

(57) ABSTRACT

An automated system and method for receiving and responding to offer(s) based on predetermined criteria is disclosed. The automated system and method facilitates the sale of products/services over a computer network, e.g., the Internet or the World Wide Web. According to the disclosed system/method, an offer is electronically communicated to a processing system and, based on predetermined criteria, a responsive communication is electronically generated. The responsive communication generally takes the form of an acceptance of the offer, a counter-offer, or a communication regarding next steps in the negotiation process.

### CROSS-REFERENCE TO RELATED APPLICATIONS

The present application is a continuation-in-part application that claims the benefit of a co-pending non-provisional patent application entitled “Automated Offer-Based Negotiation System and Method,” that was assigned Ser. No. 10/616,878 and was filed on Jul. 10, 2003. The entire contents of the foregoing non-provisional patent application are incorporated herein by reference.

### BACKGROUND OF THE DISCLOSURE

1. Field of the Disclosure

The present disclosure relates generally to an automated system and method for receiving and responding to offer(s) based on predetermined criteria and, more particularly, to an automated system and method for the sale of products/services over a computer network, e.g., the Internet or the World Wide Web, wherein an offer is electronically communicated to a processing system and, based on predetermined criteria, a responsive communication is electronically generated, such responsive communication generally taking the form of an acceptance of the offer, a counter-offer, and/or a communication regarding next steps in the disclosed negotiation process.

2. Discussion of Background Art

Negotiations are fundamental to countless business transactions. Numerous issues can come into play in negotiating the purchase and/or sale of goods or services, e.g., price, quality, quantity, delivery time, warranties, etc. Individuals involved in negotiating transactions often develop specialized knowledge and experience that assist them in conducting successful negotiations, i.e., negotiations of transactions wherein the terms/conditions are favorable and/or desirable.

Not all transactions are subject to negotiation. For example, typical retail purchases are generally based on fixed prices that are either accepted or rejected by a prospective purchaser. In certain instances, a price benefit may be achieved by purchasing multiple items (e.g., three items for a dollar), or by purchasing in greater bulk. In addition, cost savings may be achieved through coupons, periodic “sales prices” and/or member/frequent customer discounts.

With the advent of widespread networked communication systems, transactions are frequently undertaken through computer-based systems, e.g., over the Internet or the World Wide Web. Countless websites may be accessed that permit goods and/or services to be viewed and evaluated for potential purchase. Many websites facilitate the purchase of goods and/or services, generally at a price that is set forth at the website. Negotiation of terms, including price, is generally not possible when purchasing goods/services over the Internet.

Beyond the more traditional websites discussed above, some websites support the sale/purchase of goods and/or services at prices that may vary from time-to-time and from user-to-user. Thus, for example, certain “auction sites” permit multiple individuals to “bid” on an item, e.g., a product or service, for a preset period of time. The individual that bids the highest price is generally successful in acquiring the item. Auction sites thus function as an electronic marketplace where buyers are able to view and bid on goods/services made available by participating sellers. A market leader in the field of web-based auction sites is “eBay” (www.ebay.com).

Other websites permit an individual to submit an “offer” for the purchase of goods and/or services, and such offer is either accepted or rejected based on criteria associated with design/operation of the website. For example, the “Priceline” website (www.priceline.com) permits individuals to submit offers for hotels, airfares and the like. However, the “Priceline” site does not permit a potential purchaser to delineate all relevant parameters surrounding the desired goods/services, e.g., the precise hotel or precise air travel itinerary of interest. Moreover, websites like the “Priceline” site are unable to generate and/or communicate counter-offer(s) in response to offers that are deemed unacceptable.

Despite efforts to date, a need remains for an automated system and/or method for supporting negotiations involving goods and/or services that receives and responds to offer(s) based on predetermined criteria. In addition, a need remains for transaction systems/methods that facilitate the automated evaluation of electronic offer(s) and formulate/communicate an appropriate response (e.g., a counter-offer, acceptance and/or communication regarding the continuation of negotiations) based on predetermined criteria. Exemplary embodiments of the system and method of the present disclosure satisfy the foregoing needs, as described below.

### SUMMARY OF THE DISCLOSURE

The present disclosure is directed to an electronic system and method that facilitates automated, real-time negotiations. The disclosed system/method may be operated on any computer network, e.g., an intranet, extranet, wireless network, the Internet, the World Wide Web, and other networked computer systems. The disclosed system includes at least one server and/or processor that is programmed to evaluate an offer based on predetermined criteria, e.g., calculations that permit offer assessment based on predetermined factors and/or variables. Exemplary embodiments of the disclosed system/method advantageously permit the sale/purchase of goods and/or services at prices that provide beneficial weight to predetermined aspects of the offer, e.g., aspects that influence the variable cost to the seller, i.e., price and quantity.

According to exemplary embodiments of the disclosed system/method, an offer for goods and/or services is electronically communicated or transmitted across a network. The offer generally includes certain predetermined purchase terms, e.g., price and quantity. The offer is generally routed to and received at a server/processor, and is evaluated against predetermined criteria that are stored at such server/processor, e.g., in storage or memory associated with the server/processor. If the electronically transmitted offer satisfies the predetermined criteria, the offer is automatically accepted by the system/method, and such acceptance is electronically communicated/transmitted to the source of the offer across the network. If the offer does not satisfy the predetermined criteria, e.g., if the price is too low based on the proposed quantity to be purchased, the disclosed system/method automatically: (i) generates a counter offer or counter offers based on the predetermined criteria and transmits such counter offer or counter offers to the source of the original offer, and/or (ii) generates a communication concerning next steps in negotiations with the source of the offer, e.g., if the number of unacceptable offers exceeds a predetermined threshold the source of the offer may be advised as to the applicable waiting period before an additional offer will be processed, and/or (iii) generates a “buy now” offer price for the item of interest. Of note, the counter offer or counter offers may include one or more options for consideration by the source of the initial offer, e.g., based on multiple price/quantity combinations and a “buy now” pricing option.

If the source of the original offer finds a counteroffer acceptable, such individual communicates his/her acceptance across the network to the server/processor and the transaction is completed through conventional means, e.g., credit card purchase, products and/or service delivery, and the like. Thus, the disclosed system/method of the present disclosure offers advantageous, automated negotiation functionalities that permit an offer to be received, evaluated, accepted “as-is”, countered by way of one or more counter offers, or rejected with a communication as to next steps/time frames for continuation/resumption of the negotiations. Electronic communications are generally logged in conventional memory systems associated with the disclosed method/system, and further communication modalities are generally provided to support ancillary functions, e.g., credit checks, fulfillment functions and the like.

Exemplary embodiments of the disclosed system/method permit a system user, e.g., an administrator, to input desired predetermined criteria for use in automatically evaluating and responding to offers received at the disclosed server/processor. In addition, non-administrative individuals may post offered item(s) on the disclosed system, thereby making such item(s) available for negotiation and potential sale, as disclosed herein. Predetermined criteria for use in automatically evaluating and responding to offers for such item(s) may be input by such administrative or non-administrative users and/or may be implemented based on criteria associated with the disclosed system/method, e.g., pre-loaded algorithmic systems maintained within computer memory associated with the disclosed system/method.

One or more algorithmic systems for formulating acceptance criteria and/or generating counter-offers may be stored within memory storage associated with the disclosed system/method. The algorithmic systems may advantageously draw on real-time data in formulating acceptance criteria or generating counteroffers, e.g., current inventory levels, current promotional initiatives, etc. Thus, the formulation of acceptance criteria and/or generation of counteroffers is generally a dynamic functionality, rather than a static functionality based on pre-set and non-dynamic parameters. The administrative and/or non-administrative personnel involved in selecting desired system(s) for formulating acceptance criteria and generating counteroffers may select from available algorithmic systems and/or may input, in whole or in part, desired algorithmic system(s) for use with respect to his/her item(s).

The predetermined criteria that generally influence the formulation of acceptance criteria and generation of counteroffers may vary from time-to-time, e.g., based on marketing/sales initiatives, variations in product/service inventory, and other factors influencing or driving pricing/sales approaches. Of note, the counteroffer generated in response to a first offer may not be the same as the counteroffer generated in response to a second, but identical offer, that is subsequently received by the disclosed server/processor, based on a randomizing factor associated with the predetermined criteria disclosed herein.

According to exemplary embodiments of the disclosed system/method, operation of programming associated with the disclosed server/processor advantageously generates multiple different counter offers for transmission to the source of the offer, thereby providing such individual with multiple choices for consideration and increasing the likelihood that at least one counter offer will be acceptable to such individual. Thus, the multiple counter offers may be based on (1) accepting the offered price, provided a specified (greater) number of units (goods or services) are purchased, (2) offering a different (higher) price based on the number of units (goods or services) specified in the original offer, or (3) offering a price at which the individual may purchase the product or service immediately, without any further offers or counter offers. Additionally, the disclosed system/method may include criteria governing required modes of interaction with the system. For example, the disclosed system/method may automatically set time and/or navigational criteria for continued negotiations, e.g., the source of the offer must respond within “x” minutes without navigating to another website, thereby increasing the impetus for the individual to reach a purchase agreement pursuant to the disclosed system/method. The disclosed system/method may also advantageously restrict an individual's ability to submit a new/revised offer for a period of time (i.e., a pre-set “wait period”). For example, an individual would be prevented from submitting/transmitting further offers (either for the same products/services or for any products/services) for a predetermined period of time once “x” number of offers/counteroffers have been exchanged by the system and such individual with respect to a product/service.

Additional advantageous features and functionalities of the disclosed system/method will be apparent to persons skilled in the art from the detailed description, appended drawings and claims which follow.

### BRIEF DESCRIPTION OF THE DRAWINGS

So that those of ordinary skill in the art to which the subject disclosure pertains will more readily understand how to design and use the system and method of the present disclosure, exemplary embodiments will be described with reference to the drawings appended hereto, wherein:

FIG. 1 is block diagram that schematically illustrates certain electronic communications associated with the exemplary embodiments of the disclosed system and method;

FIG. 2 is a further block diagram that schematically illustrates a series of steps associated with price-based negotiations according to exemplary embodiments of the present disclosure; and

FIGS. 3 to 16 are screen shots derived from Internet-based examples of the disclosed system and method.

### DESCRIPTION OF EXEMPLARY EMBODIMENT(S)

The present disclosure generally provides an automated system and method for receiving and responding to offer(s) based on predetermined criteria and, more particularly, an automated system and method for the sale of products/services over a computer network, e.g., the Internet or the World Wide Web. According to the disclosed system/method, an offer is electronically communicated to a processing system across the computerized network and, based on predetermined criteria, a responsive communication is electronically generated at a disclosed server/processor in real-time. The responsive communication generally takes the form of an acceptance of the offer, a counteroffer and/or a communication as to next steps/time frames for continuation/resumption of the negotiation process.

The disclosed system/method advantageously automates a negotiation regimen, in real-time, such that an electronically communicated offer may be automatically evaluated against predetermined acceptance criteria for offer acceptance and, to the extent the offer does not satisfy such predetermined acceptance criteria, a counter offer may be formulated and communicated to the source of the original offer. According to exemplary embodiments, the counter offer may advantageously include a plurality of price/quantity combinations. In such circumstance, each of the price/quantity combinations is generated at the server/processor based on predetermined criteria and, preferably, generated using a randomizing factor. In any event, each of the combinations reflects a business proposition that is desirable/acceptable to the seller based on the predetermined criteria that are supplied to, and operated by, the disclosed server/processor. By providing multiple price/quantity combinations in the automated counter offer, the system/method of the present disclosure increases the likelihood that a transaction will be successfully consummated between the source and recipient of the initial offer.

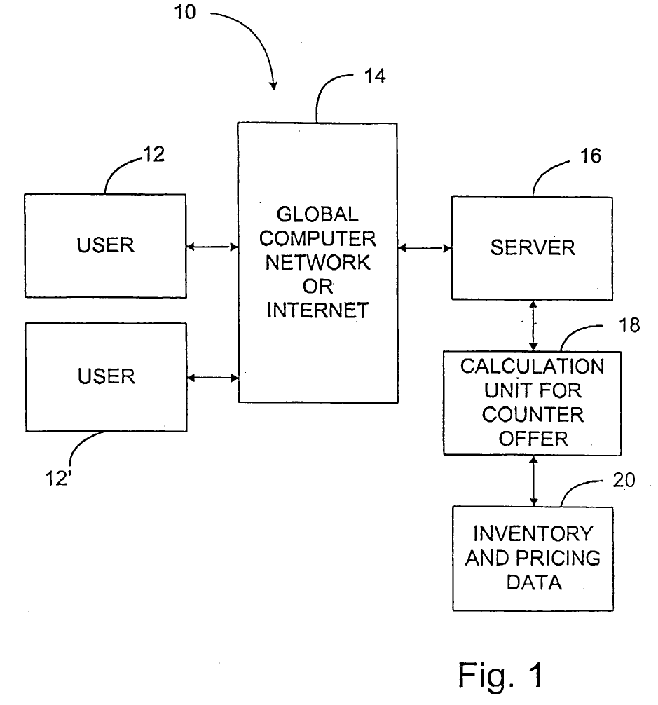

With reference to the appended figures, FIG. 1 schematically illustrates an exemplary system 10 according to the present disclosure. Multiple users 12, 12′ are electronically connected to a computer network 14, e.g., an intranet, extranet, wireless network, the Internet, the World Wide Web or another computerized network. Although two users are schematically depicted in FIG. 1, the present disclosure contemplates an infinite number of users accessing the disclosed system/method of the present disclosure (subject to system capacity, as is known to persons skilled in the art). The users may be located in a variety of remote locations, and may be accessing the disclosed system/method in their personal and/or professional capacity, i.e., to satisfy their personal interests or the interests of their employer. The users 12, 12′ may access computer network through any suitable electronic device, e.g., a personal computer, laptop computer, personal digital assistant, wireless communication device, e.g., a telephone or cellular phone, or the like.

The computer network 14 is connected to or communicates with one or more servers or processors 16 that is adapted to operate system programming according to the present disclosure. Thus, associated with server/processor 16 is a calculation unit 18, i.e., processing functionality that operates to perform calculations as described herein. Calculation unit 18 is particularly adapted for accessing offer(s) received across the network, e.g., from users 12, 12′, determining whether the offer(s) are acceptable based on predetermined criteria and, to the extent the offer(s) fail to satisfy the predetermined criteria, generating one or more counter offers for transmission to such user(s) and/or communicating as to next steps/time frame for continuing/resuming the negotiation process. According to exemplary embodiments of the present disclosure, calculation unit 18 calculates one or more acceptable pricing formulations that are incorporated into counter offers, such pricing formulations generally reflecting one or more advantageous price/quantity combinations.

The counter offers, which incorporate the proposed pricing formulation(s), are generated based on predetermined negotiation system criteria and/or predetermined values stored in data storage unit 20 that is associated with the server/processor 16. For purposes of the present disclosure, the terms “predetermined negotiation system criteria” and “predetermined criteria” refer to algorithmic systems, formulae, databases and/or data tables that are pre-selected or predefined by a system user or by the system itself, and are then accessed and/or run by a server or processor to determine, calculate or generate acceptable business terms for a potential transaction, e.g., acceptable combinations of price and quantity. Data storage 20 generally stores information and/or data that constitutes and/or is relevant to calculating the predetermined criteria according to the negotiation system/method of the present disclosure, e.g., inventory and pricing data on different products and services available to users of the disclosed system 10. Of note, however, the calculation unit advantageously communicates with a source of “real time” or periodically updated data for use in generating counteroffers, e.g., current inventory levels and the like.

According to exemplary embodiments of the present disclosure, calculation unit 18 may be used to calculate or generate a plurality of counter offers to be provided to a user 12, 12′ based upon predetermined negotiation system criteria. In the predetermined negotiation system criteria, different price breaks or prices may be set for a predetermined or predefined number of units. The price breaks or pricing may also be determined by a predetermined percentage of a starting cost based upon the number of units. Thus, the price breaks and/or pricing may be calculated and/or generated based upon a variety of parameters, and such parameters may be inter-related in a variety of ways, as will be apparent to persons skilled in the art based on the present disclosure.

Additionally, different counter offers may be generated for each offer that is made and received by the disclosed server/processor. This variability may be achieved by incorporating a randomization factor into the process of determining, calculating and/or generating counter offers. The randomization factor may be determined/incorporated into the counter offer process in a variety of ways. For example, a randomized counter offer may be generated/calculated by predefining a predetermined price for the number of units requested and adjusting it by a randomly determined amount. In an exemplary embodiment, the randomized adjustment may range from zero to a predetermined counter offer adjustment range or amount (up to 100%) of the predetermined price for the specified units.

All aspects of the randomization factor and its calculation by the disclosed system/method may be advantageously set/determined by users/administrators of the system/method. As a result, a slightly different price, varying by a maximum of the predetermined counter offer range, may be provided to different users making identical offers, or to a user that provides the same offer more than once.

Thus, exemplary embodiments of the disclosed system/method facilitate negotiations with potential consumer(s), in real time, based on an algorithm that takes into account predetermined price breaks for a product and/or service, coupled with a quantity acceptable for each price break. These price breaks may be fixed dollar amounts or a various percentage above a fixed cost. There is no limit to the number of price breaks set nor the range between breaks.

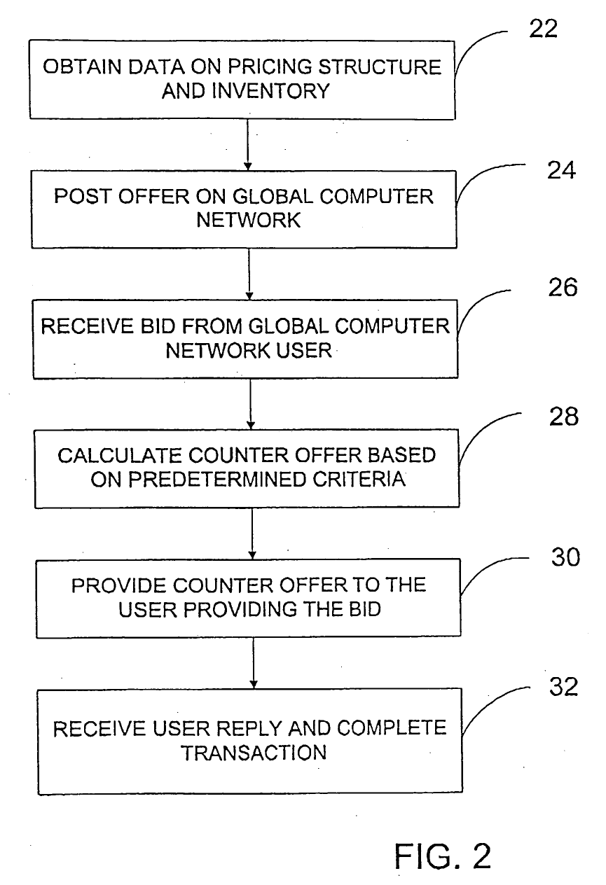

FIG. 2 is a block diagram illustrating method steps associated with exemplary embodiments of the present disclosure. Block 22 represents the step of obtaining data on factors and/or data relevant to the negotiation system, e.g., pricing structure and available inventory. Block 24 represents the step of posting an offer to sell a product or service on a computer network, e.g., an intranet, the Internet, etc. Block 26 represents the step of receiving an offer from a user across or via the computer network. For an offer that is deemed unacceptable, block 28 represents the step of calculating one or more counter offers based on the price or quantity requested by a user and predetermined criteria associated with the disclosed system/method. Thus, factors and/or data, such as inventory data (as then-contained in data base storage or as obtained in from an appropriate source in “real time”) and predefined negotiation criteria, are utilized to generate/calculate appropriate counter offer(s) pursuant to the disclosed system/method. Block 30 represents the step of providing or communicating a counter offer to a user in response to the offer initially received from such user. Block 32 represents the step of repeating the offer-counter offer cycle or completing a transaction should the counter offer be accepted by the user.

To further describe the disclosed system and method, several exemplary embodiments and examples, which further elucidate illustrative implementations of the disclosed automated negotiation process, are described herein below. It is to be understood, however, that the following implementations and examples are merely illustrative of the disclosed system/method, and that the disclosed system/method is not limited thereto.

According to a first exemplary implementation, the predetermined criteria are set such that, if an offer falls below one of the predetermined price breaks that would be deemed acceptable by applicable acceptance criteria, then three counter offers will be presented to the buyer, as follows:

1. If the price falls within one of the price breaks, but the quantity requested is below the quantity preset for that price break, the disclosed system/method automatically notifies the potential buyer that his/her offer is not accepted, but that the price offered will be accepted so long as the buyer agrees to purchase the quantity preset for the price break by the seller, i.e., within the predetermined criteria.

2. As an alternative or second counter offer to #1 above, the disclosed system/method automatically finds the price break within which the quantity requested by the buyer falls. The system/method then takes this price break dollar amount and multiplies it by a random number generated by the server/processor and multiplies this product by a range set by the seller, i.e., set within the predetermined criteria. This figure is then added to the original price break dollar amount producing a counter offer which is presented/communicated to the buyer for the number of units requested.

3. As an additional option to the buyer, if #1 or #2 are not acceptable to the buyer, option #3 simply allows the buyer to buy the unit immediately for a fixed price set by the seller, i.e., within the predetermined criteria. This “Buy Now” feature is advantageously part of every offer/counter offer.

According to exemplary embodiments of the present disclosure, a potential buyer of a product or service can only make an offer at predetermined intervals set by the buyer, i.e. once every twenty four (24) hours, once every forty eight (48) hours, once during the life of the offer, or any other interval the seller chooses.

The seller of a product or service is generally provided with the ability to set the following variables/parameters which initialize system for a given product or service.

1) Price breaks and quantities acceptable for each price break:

These price breaks may also be represented in a starting cost and percentage increments which will produce fixed price breaks from this data.

2) The “wait period” duration, which the buyer has to wait to make a repeated/follow-up offer on the same product/service:

This can be any duration, but common values will be in the twenty four (24) hour to life of the offer range. The system may advantageously check several aspects of a buyer's personal data to verify and/or determine if he/she has already made an offer within the predefined repeat offer duration period.

3) The counter offer range which is used to calculate the counter offer made by the system:

The counter offer range may be from 0 to infinity, although more common or preferred values will be in the 0.05 to 0.2 range. A separate counter offer range may, and generally is, set for each price break, or the range can be the same, whichever the seller chooses in predefining the relevant predetermined criteria.

4) The quantity available for sale, i.e., for which potential buyers may submit offers according to the disclosed system/method:

This quantity is automatically reduced for each offer accepted and/or purchase made.

5) The “Buy Now” price which the buyer can accept at any time:

The Buy Now price is generally included in the predetermined criteria by the seller.

The following table illustrates an exemplary relationship between fixed price and # of unit breaks which may be set by the seller, i.e., within the predetermined criteria. According to the present disclosure, there is no limit to the number of price breaks that may be set or defined within the predetermined criteria.

TABLE 1

| Price Break | # units | Counter Offer Range |
|---|---|---|
| 5.00 | 12 | .10 |
| 6.00 | 8 | .10 |
| 7.00 | 6 | .10 |
| 8.00 | 4 | .10 |
| 9.00 | 2 | .10 |
| 10.00 | 1 | .10 |

Additional information that may be advantageously included in the predetermined criteria, i.e., beyond the type of information set forth in Table 1, include:

The wait period duration for repeat offers: 24 hours

Global Counter Offer Range (used if not set on a per level basis)—0.10

# of units Available—100 units

Buy Now Price: $19.99

According to the present disclosure, price breaks may also be determined by a starting cost and percentage breaks. For example, the following exemplary percentages may be used, which equate to the following price break chart (Starting Cost: $5.00):

TABLE 2

| Percentage | Creates this Price Break | # units (set by seller) |
|---|---|---|
| 0 | 5.00 | 12 |
| .2 ($5.00 × 1.2) | 6.00 | 8 |
| .3 ($5.00 × 1.3) | 6.50 | 6 |
| .4 ($5.00 × 1.4) | 7.00 | 4 |
| .5 ($5.00 × 1.5) | 7.50 | 2 |
| .6 ($5.00 × 1.6) | 8.00 | 1 |

The duration, counter offer range for each level, the global counter offer range, the # of units available, and buy now price may also be set or predefined as part of the predetermined criteria, as discussed above.

Additional exemplary implementations of the disclosed system/method are set forth below, with reference in certain circumstances to the above-noted tables.

Example #1:

Buyer offers $12.50 for one (1) unit of whatever product or service is being offered in Table 1

Result: Offer is accepted and buyer is notified.

Example #2:

Buyer offers $8.35 for four (4) units of whatever product or service is being offered in Table 1.

Result: Offer is accepted and buyer is notified.

Example #3:

Buyer offers $8.50 for two (2) units of whatever product or service is being offered in Table 1.

Result: Three (3) counter offers are presented:

1. Price will be accepted if buyer can take four (4) units.

2. A price generated by our negotiation system will be offered to the buyer for the two (2) units requested.

3. The “Buy Now” price of $19.99 is also offered as an option to the buyer.

Of note, the buyer may also be notified that he/she can try again, i.e., make an additional/follow-up offer, after the applicable (e.g., twenty four (24) hour) repeat offer duration period has expired.

Example #4:

Buyer offers $6.75 for 200 units of whatever product or service is being offered in Table 1.

Result: Two (2) counter offers are presented (and the Buy Now option):

1. Price will be accepted if buyer can take the remaining 100 units on hand. Since there are only 100 units left, that is all that is offered to the buyer.

2. Since the number of units requested exceed the lowest price break quantity, there is no 2^{nd} option presented in this case.

3. The “Buy Now” price of $19.99 is also offered as an option to the buyer

Of note, the buyer may also be notified that he/she can try again, i.e., make an additional/follow-up offer, after the applicable (e.g., twenty four (24) hour) repeat offer duration period has expired.

Example #5:

Buyer offers $4.00 for one (1) unit of whatever product or service is being offered in Table 1.

Result: Two (2) counter offers are presented (and the Buy Now option).

1. Since the price falls below the minimum price break for one (1) unit, this counter offer is not presented at all in this case.

2. A price generated by the disclosed negotiation system/method will be offered to the buyer for the one (1) unit requested.

3. The “Buy Now” price of $19.99 is also offered as an option to the buyer

Of note, the buyer may also be notified that he/she can try again, i.e., make an additional/follow-up offer, after the applicable (e.g., twenty four (24) hour) repeat offer duration period has expired.

Example #6—Example of Calculating Counter Offer(s)

Assumptions:

1) Offer made is $7.50;

2) Quantity requested is four (4) units;

3) Random Number generated is 0.57;

4) “PriceBreakDollarAmount” is $8.00; and

5) Counter Offer Range for this level is 0.10

Formula: (PriceBreakDollarAmount*RandomNumber*Range)+PriceBreakDollarAmount

($8.00*0.57*0.10)+$8.00=$8.456 is counter offer for four (4) units

In this example #6, an exemplary method/formula for using predefined negotiation criteria to calculate a counter offer is illustrated according to the disclosed system/method. In this embodiment, a random number is used between 0.00 and 1.00 to calculate a counter offer that is within a predetermined range, in this example 10% of a predetermined dollar amount. In this example, the counter offer for four (4) units having a price break dollar amount of $8.00 will range randomly between $8.00 and $8.80, depending upon the randomly generated number between 0.00 and 1.00 multiplied by the range of 10%.

Example 7—Working Internet-based Example

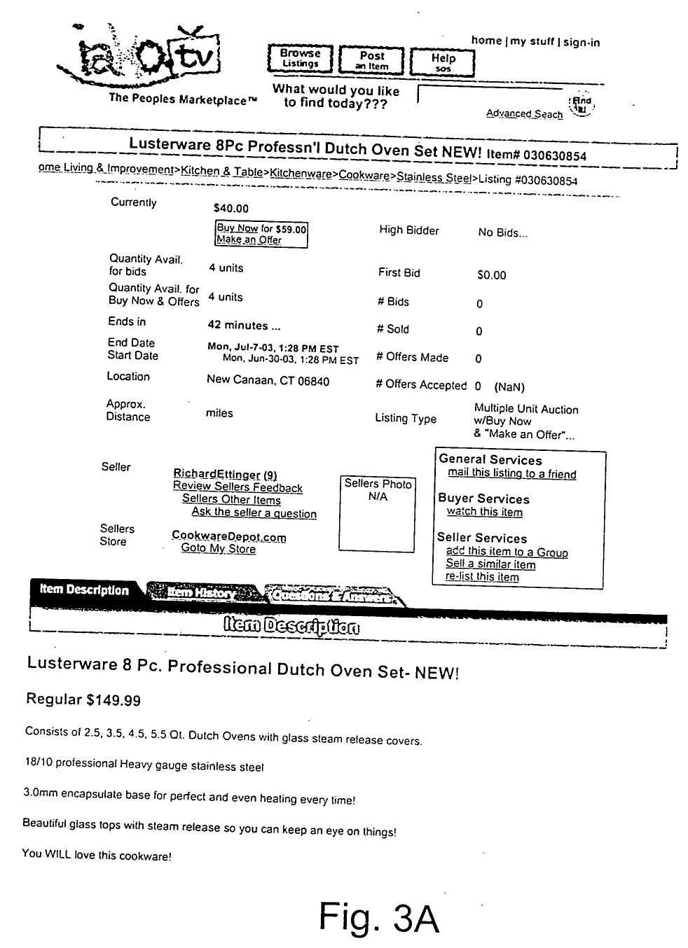

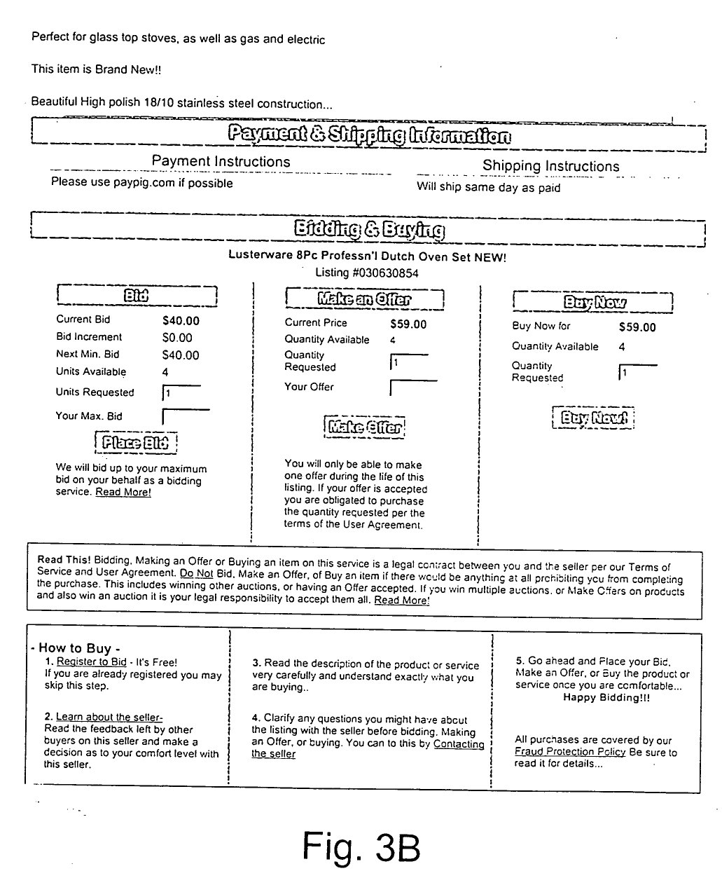

With reference to FIGS. 3-9, a Lusterware 8 piece professional Dutch oven cookware set was listed for sale at a website supporting Internet-based sales transactions. In making the cookware set available for sale, the system of the present disclosure was employed on the back-end to evaluate and respond to offer(s) received in response to the sales listing. The parameters selected according to the disclosed system were as follows:

| Price | Quantity | Counter Offer Range |
|---|---|---|
| $50.00 | 1 unit | 10% |
| $45.00 | 2 units | 10% |
| $40.00 | 4 units | 10% |

The total number of units available was set at four (4). The wait period was set for twenty four (24) hours. The “Buy Now” price was set at $59.00. Information associated with the preset parameters according to the system of the present disclosure are set forth in the screen shot of FIGS. 3A and 3B.

Information concerning the cookware set was made available for viewing on a webpage 300, as shown in the screen shots of FIGS. 3A and 3B. With particular reference to FIG. 3B, the “Make an Offer” block 302 and “Buy Now” block 304 are directly associated with the subject matter of the present disclosure. Thus, in the Make an Offer block 302 shown on FIG. 3B, a current price of $59.00 (which corresponded to and was derived from the Buy Now price defined herein above) and the Quantity Available (four) were displayed. In addition, webpage 300 provided the potential purchaser with two (2) input boxes within Make an Offer block 302, namely “Quantity Requested” box 306 and “Your Offer” box 308. Upon entering values into boxes 306, 308, the potential purchaser submitted the offer for consideration by clicking on the “Make Offer” box 310.

Alternatively, the potential purchaser was free to purchase the cookware set at the Buy Now price of $59.00 by entering the desired quantity in the “Quantity Requested” box 312 within Buy Now block 304. Upon entering the desired quantity, the order could be submitted by clicking on the “Buy Now” box 314.

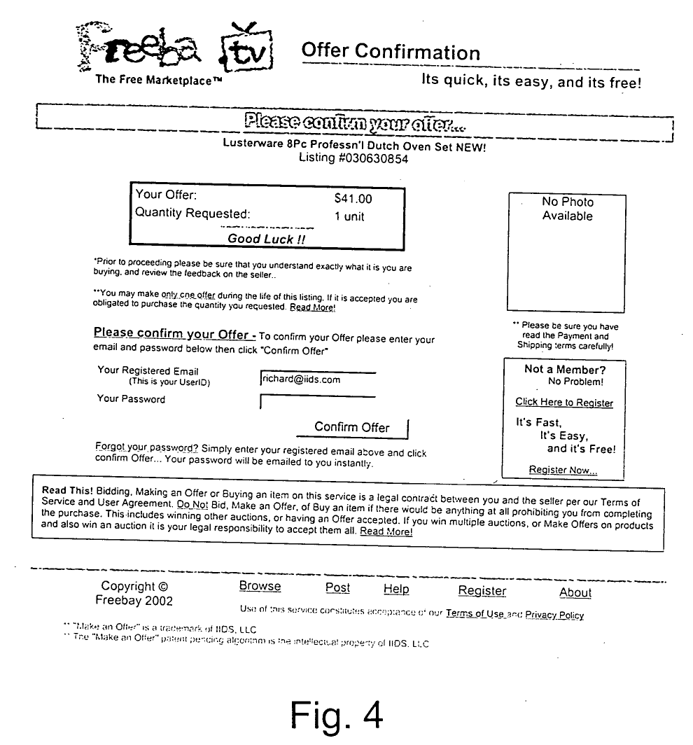

According to the present disclosure and with reference to FIG. 4, a first offer of $41.00 for one (1) unit was submitted to the system by a potential purchaser. Offer confirmation 200 is shown in FIG. 4. The system of the present disclosure automatically evaluated the first offer in terms of price and quantity, and determined that such offer did not satisfy the predetermined price ($50.00) for a quantity of one.

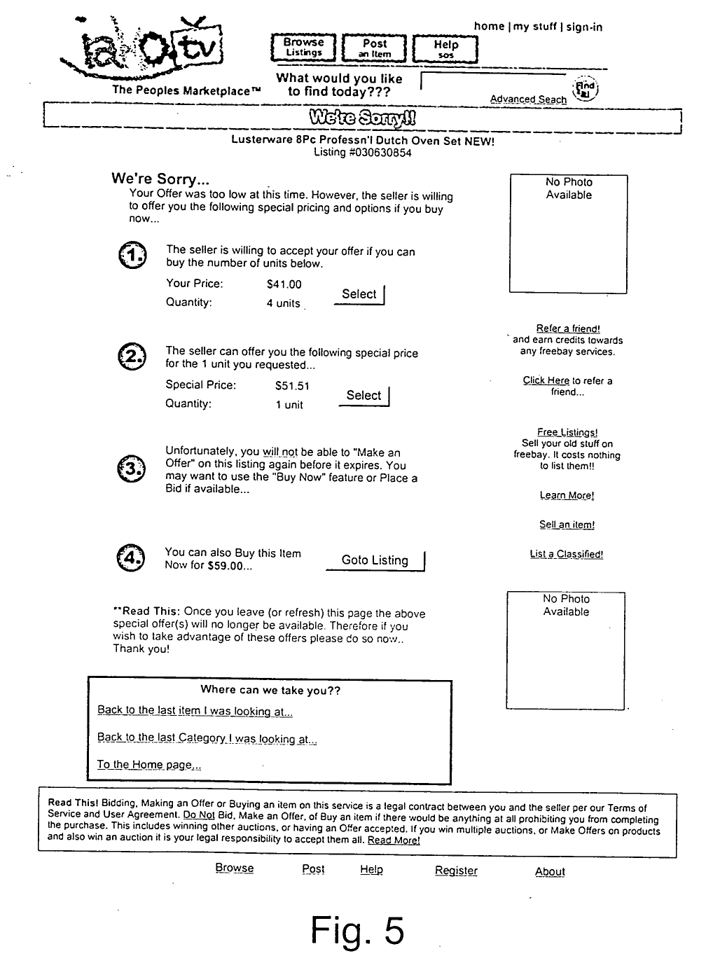

Based on such evaluation, the system of the present disclosure rejected the first offer and automatically provided a four-point responsive communication to the potential purchaser, as shown in screen shot 500 of FIG. 5. In particular, the disclosed system generated a first counter-offer at the price proposed by the potential purchaser, i.e., $41.00. Based on the pre-set parameters set forth above, the system determined that a price of $41.00 exceeded the threshold price for a quantity of four (i.e., $40.00), and therefore the first counter-offer 502 proposed four units at a price of $41.00.

Alternatively, the second counter-offer was based on the requested quantity of one and was again based on the pre-set parameters set forth above. The system automatically determined that a price of $50.00 (with a counter offer range of 10%) was acceptable for a single cookware set and, based on the randomization factor, arrived at the second counter-offer 504 of one unit for $51.51.

The third point of communication apprised the potential purchaser of the temporal limitation on his/her use of the Make an Offer function. Thus, as set forth in communication block 506, the potential purchaser was advised that additional Make an Offer submissions would not be possible within the prescribed timeframe, based on the pre-set temporal parameter set forth above.

Finally, the fourth communication box 508 reiterated the Buy Now option available to the potential purchaser at the Buy Now price of $59.00.

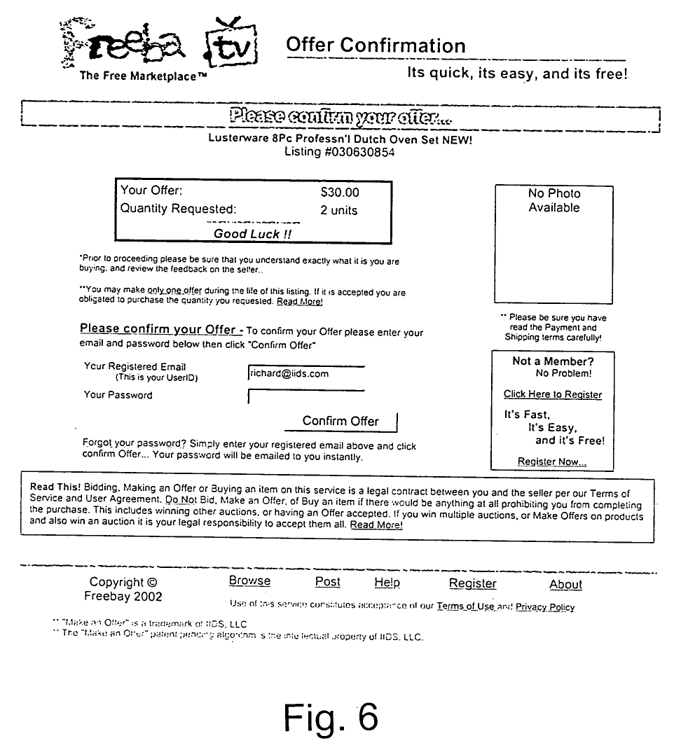

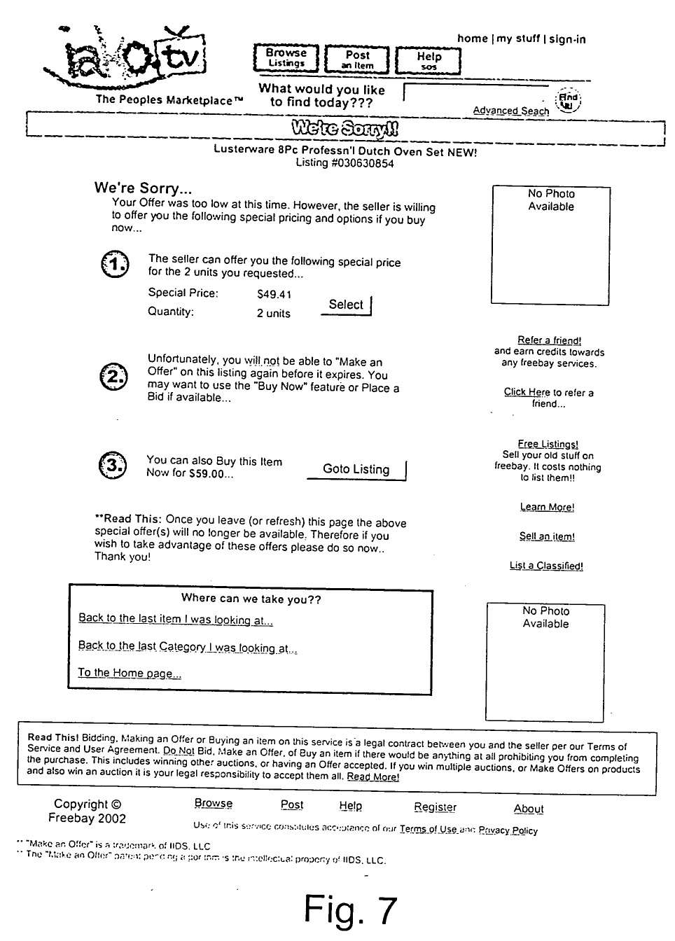

With reference to screen shot 600 of FIG. 6, a second offer was made for the Lusterware 8 piece professional Dutch oven cookware set as follows: 2 units for $30.00 each. In response and as shown in screen shot 700 of FIG. 7, the system of the present disclosure automatically rejected the second offer, but responded with a three point communication. In the first counter offer 702, the potential purchaser was offered an alternative price for the quantity requested (i.e., two units), based on the pre-set parameters set forth above. Thus, the first counter offer 702 was based on the pre-set price of $45.00 for two units (with a counter offer range of 10%), and was extended at a price of $49.41 (based on a randomization factor).

A counter-offer was not extended at the price proposed by the potential purchaser (i.e., $30.00 per unit) because the pre-set parameters did not extend as low as $30.00 (the lowest price was set at $40.00). Thus, the second communication box 704 provided temporal information and the third communication box 706 reiterated the Buy Now option available to the potential purchaser at the Buy Now price of $59.00.

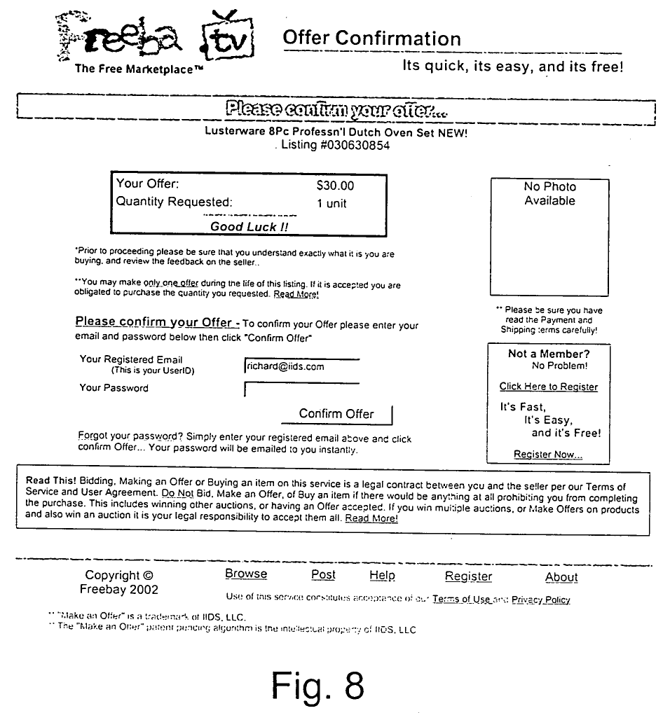

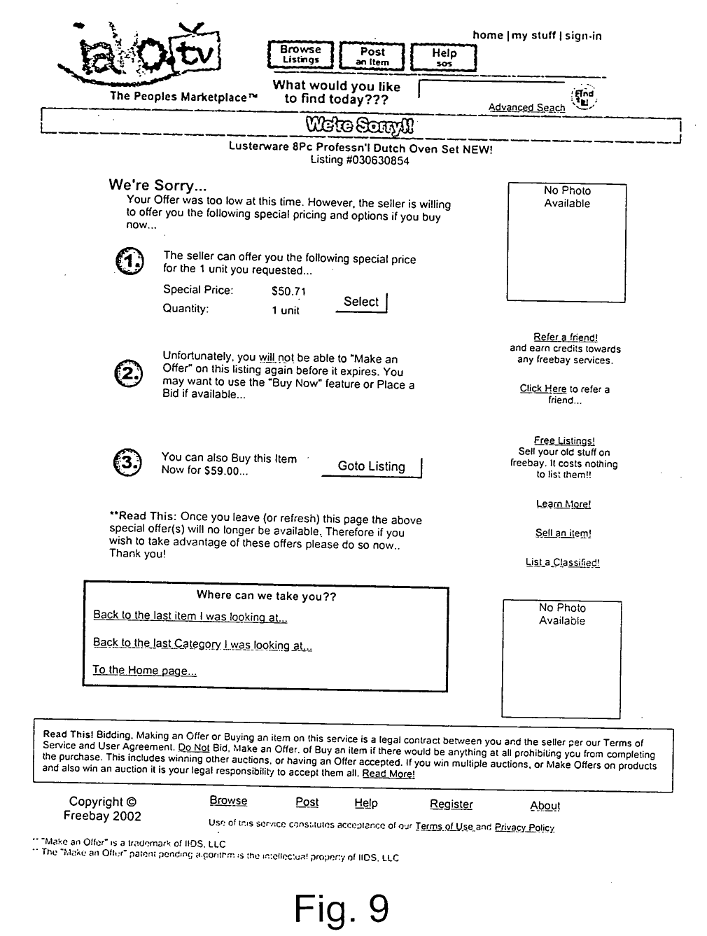

With reference to screen shot 800 of FIG. 8, a third offer was made for the Lusterware 8 piece professional Dutch oven cookware set as follows: 1 unit at $30.00. In response and as shown in screen shot 900 of FIG. 9, the system of the present disclosure automatically rejected the third offer, but responded with a three point communication. In the first counter offer 902, the potential purchaser was offered an alternative price for the quantity requested (i.e., one unit), based on the pre-set parameters set forth above. Thus, the first counter offer 902 was based on the pre-set price of $50.00 for one unit (with a counter offer range of 10%), and was extended at a price of $50.71 (based on a randomization factor).

As with the second offer, a counter-offer was not extended for the third offer at the price proposed by the potential purchaser (i.e., $30.00 per unit) because the pre-set parameters did not extend as low as $30.00 (the lowest price was set at $40.00). Thus, the second communication box 904 provided temporal information and the third communication box 906 reiterated the Buy Now option available to the potential purchaser at the Buy Now price of $59.00.

Example 8—Second Working Internet-based Example

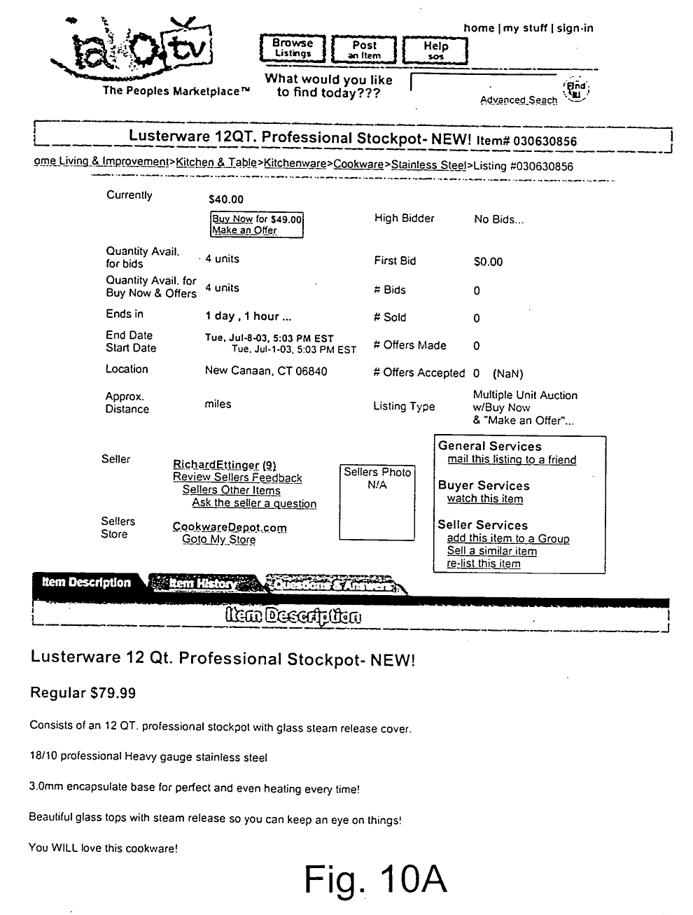

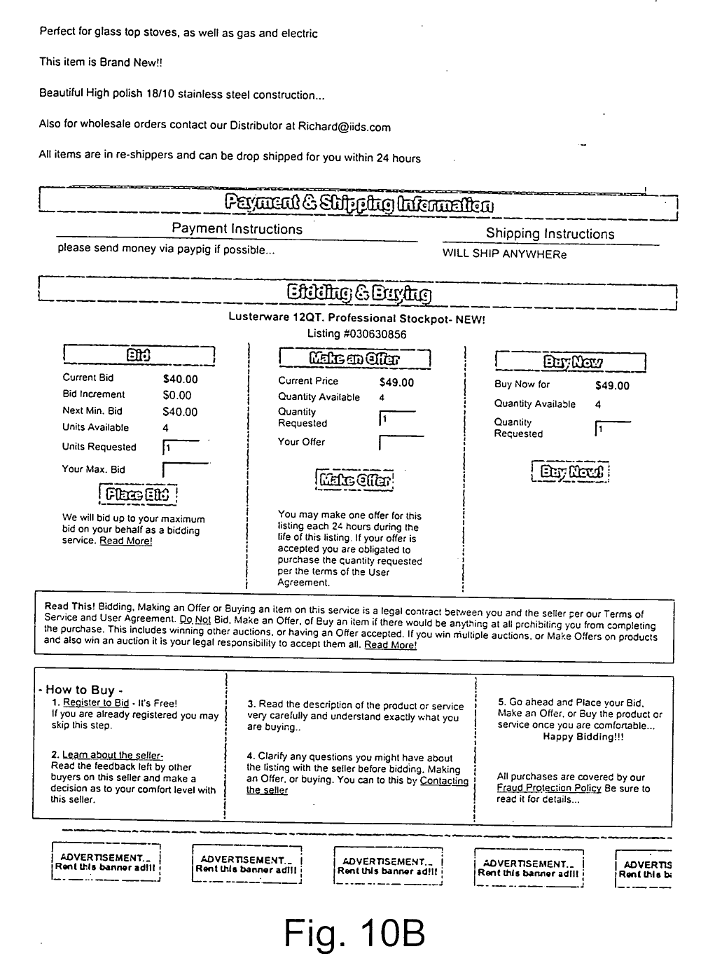

With reference to FIGS. 10-16, a Lusterware 12 quart professional stockpot was listed for sale at a website supporting Internet-based sales transactions. In making the stockpot available for sale, the system of the present disclosure was employed on the back-end to evaluate and respond to offer(s) received in response to the sales listing. The parameters selected according to the disclosed system were as follows:

| Price | Quantity | Counter Offer Range |
|---|---|---|
| $45.00 | 1 unit | 10% |
| $40.00 | 2 units | 10% |
| $36.00 | 4 units | 10% |

The total number of units available was set at four (4). The wait period was set for twenty four (24) hours. The “Buy Now” price was set at $49.00. Information associated with the preset parameters according to the system of the present disclosure are set forth in the screen shot of FIGS. 10A and 10B.

Information concerning the stockpot was made available for viewing on a webpage 1000, as shown in the screen shots of FIGS. 10A and 10B. With particular reference to FIG. 10B, the “Make an Offer” block 1002 and “Buy Now” block 304 are directly associated with the subject matter of the present disclosure, and are identical in design and function to the blocks described with reference to FIG. 3B, which description is incorporated herein by reference.

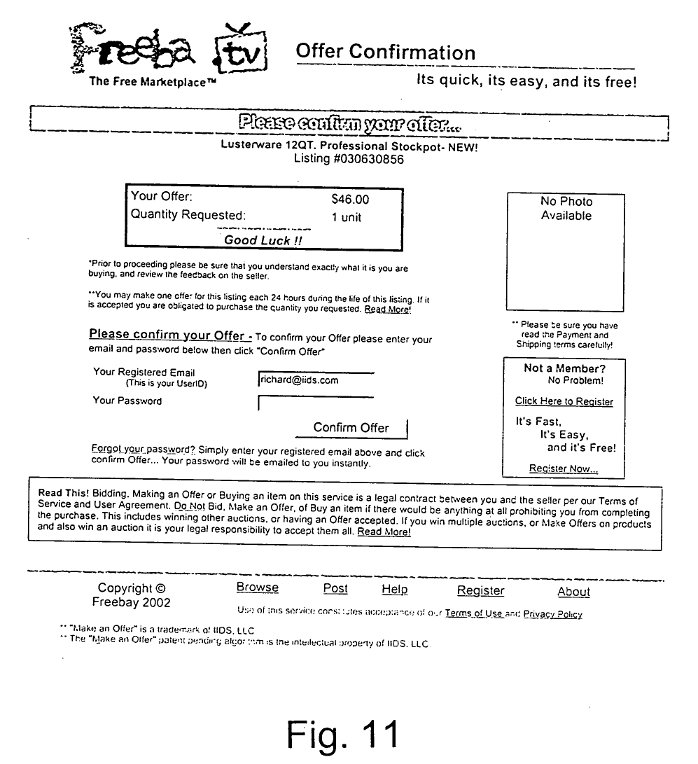

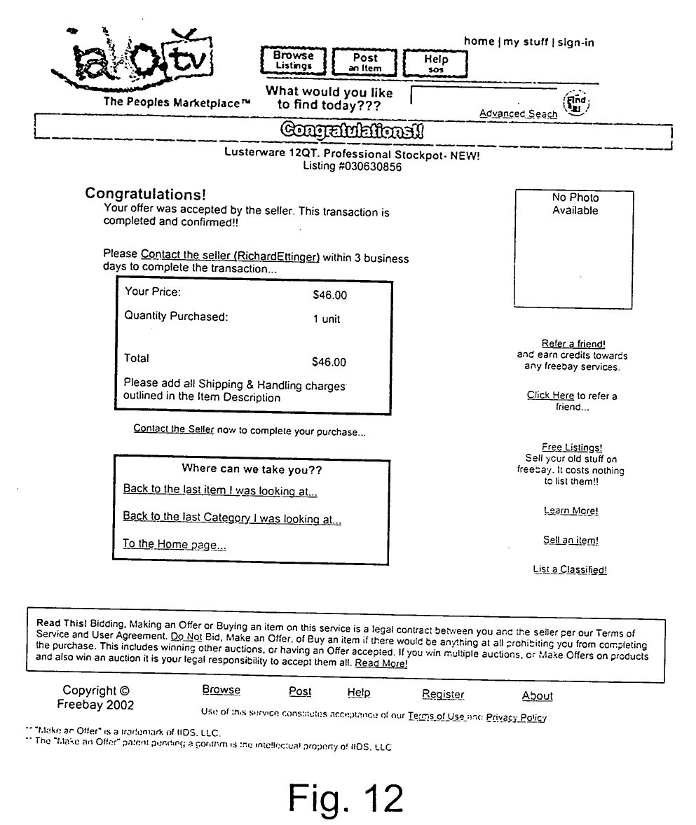

According to the present disclosure and with reference to FIG. 11, a first offer of $46.00 for one (1) unit was submitted to the system by a potential purchaser. Offer confirmation 1100 is shown in FIG. 11. The system of the present disclosure automatically evaluated the first offer in terms of price and quantity, and determined that such offer satisfied the predetermined price ($45.00) for a quantity of one. Thus, as shown in screen shot 1200 of FIG. 12, the first offer was automatically accepted by the system of the present disclosure, and the purchaser was provided with guidance as to obtaining the purchased item.

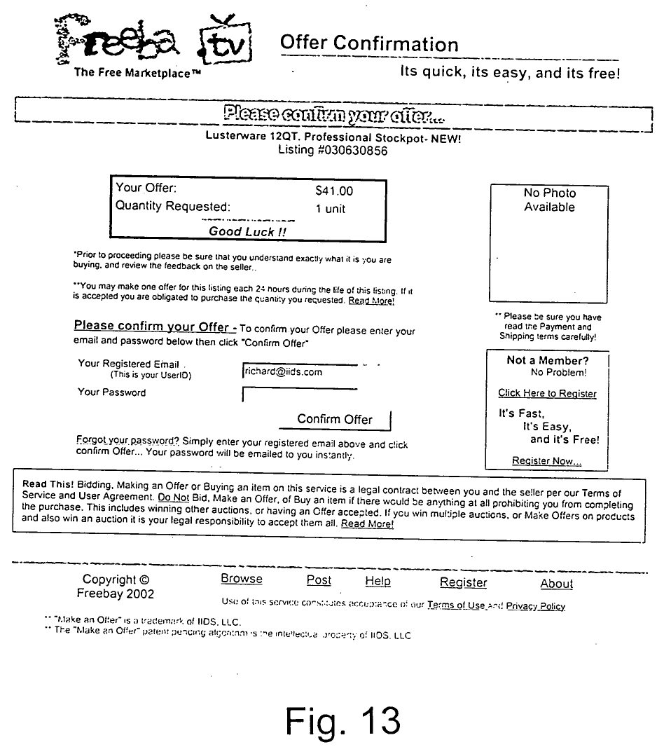

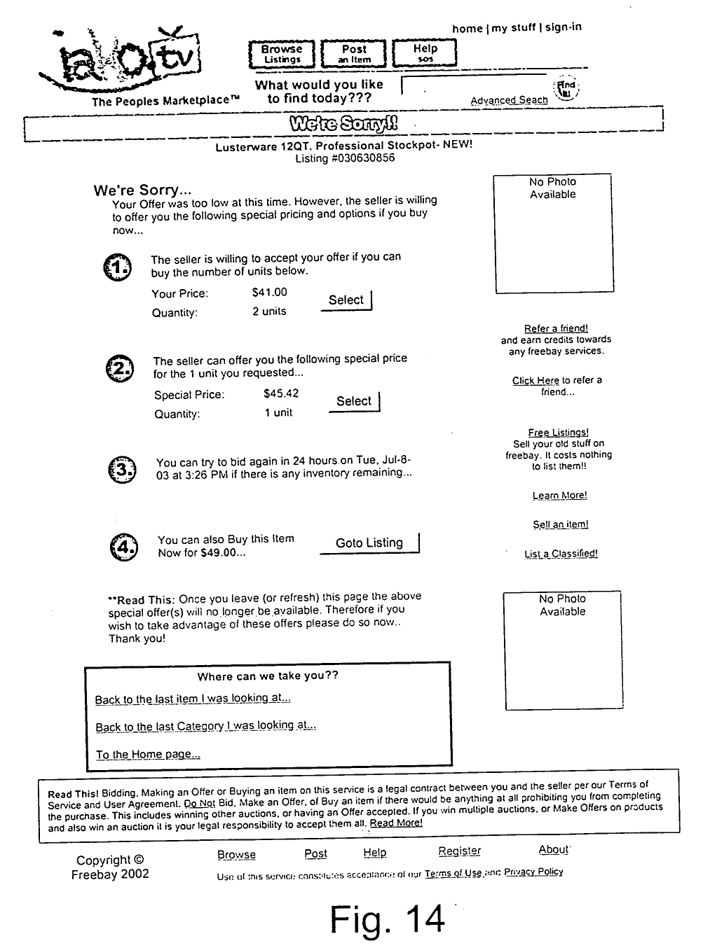

With reference to screen shot 1300 of FIG. 13, a second offer was made for the Lusterware 12 quart stockpot as follows: 1 unit for $41.00. In response and as shown in screen shot 1400 of FIG. 14, the system of the present disclosure automatically rejected the second offer, but responded with a four point communication. In the first counter offer 1402, the potential purchaser was offered an alternative quantity for the price requested ($41.00), based on the pre-set parameters set forth above. Thus, since the first counter offer 1402 exceeded the threshold price of $40.00 for two units, the first counter offer 1402 was extended at a price of $41.00 for two units.

Alternatively, the second counter-offer was based on the requested quantity of one and was again based on the pre-set parameters set forth above. The system automatically determined that a price of $45.00 (with a counter offer range of 10%) was acceptable for a single stockpot and, based on the randomization factor, arrived at the second counter-offer 1404 of one unit for $45.42.

The third communication box 1406 provided temporal information based on the twenty four hour response period included in the pre-set parameters, and the fourth communication box 1408 reiterated the Buy Now option available to the potential purchaser at the Buy Now price of $49.00.

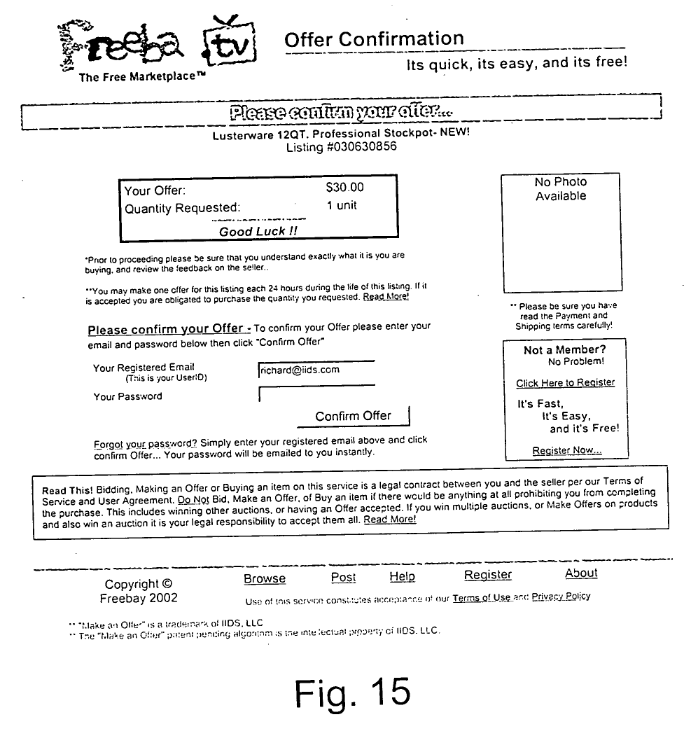

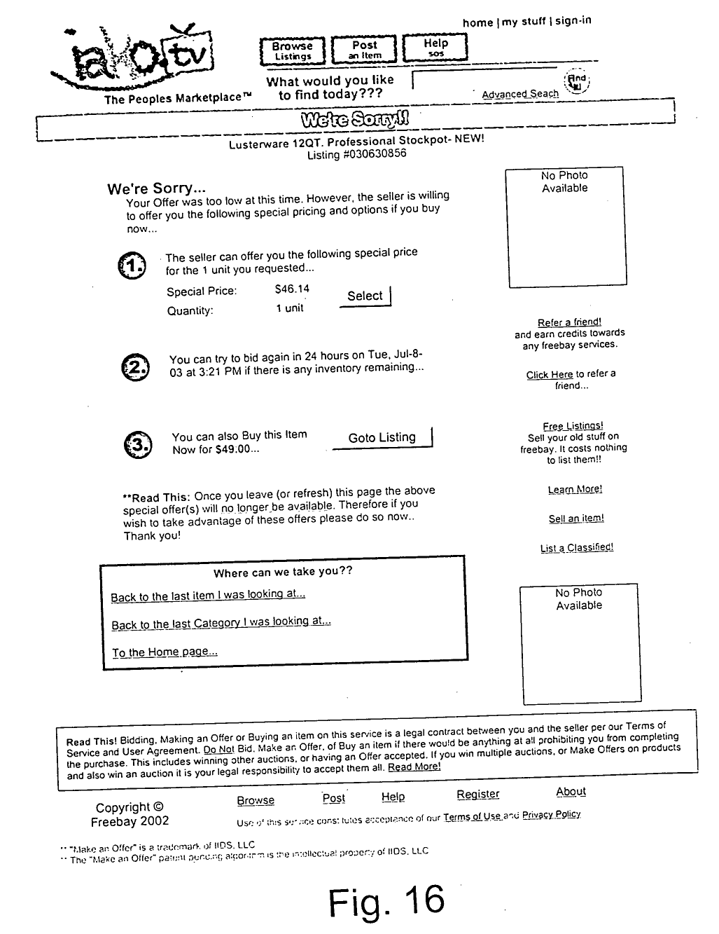

With reference to screen shot 1500 of FIG. 15, a third offer was made for the Lusterware 12 quart stockpot as follows: 1 unit at $30.00. In response and as shown in screen shot 1600 of FIG. 16, the system of the present disclosure automatically rejected the third offer, but responded with a three point communication. In the first counter offer 1602, the potential purchaser was offered an alternative price for the quantity requested (i.e., one unit), based on the pre-set parameters set forth above. Thus, the first counter offer 1602 was based on the pre-set price of $45.00 for one unit (with a counter offer range of 10%), and was extended at a price of $46.14 (based on a randomization factor).

A counter-offer was not extended for the third offer at the price proposed by the potential purchaser (i.e., $30.00 per unit) because the pre-set parameters did not extend as low as $30.00 (the lowest price was set at $36.00). Thus, the second communication box 1604 provides temporal information and the third communication box 1606 reiterated the Buy Now option available to the potential purchaser at the Buy Now price of $49.00.

According to a further exemplary implementation, the predetermined criteria are set such that, if an offer falls below one of the predetermined price breaks that would be deemed acceptable by applicable acceptance criteria, then three counter offers will be presented to the buyer, as follows:

1. If the price falls within one of the price breaks, but the quantity requested is below the quantity preset for that price break, the disclosed system/method automatically notifies the potential buyer that his/her offer is not accepted, but that the price offered will be accepted so long as the buyer agrees to purchase the quantity preset for the price break by the seller, i.e., within the predetermined criteria.

2. As an alternative or second counter offer to #1 above, the disclosed system/method automatically finds the price break value for the quantity requested by the buyer. According to this further exemplary embodiment, the foregoing price break value is utilized as a “lower boundary” in defining a “price break range.” The “upper boundary” for such price break range corresponds to the preset price for the next lower quantity of items. The “next lower quantity” may differ from the quantity requested by a single unit or by some greater differential, e.g., five units, ten units, etc., as may be selected by the seller in establishing desired quantity/price thresholds. For example, if the quantity requested by the buyer is “3” units, the “lower boundary” (which corresponds to the preset price for “3” units) might be $8.00, while the “upper boundary” (which corresponds to the preset price for “2” units or the next-specified unit level) might be $9.00. Thus, according to this further exemplary embodiment, the disclosed system/method calculates the difference between the upper and lower boundaries (i.e., $9.00−$8.00=$1.00) and multiplies such difference by a random number generated by the server/processor. In the case of the highest price break value, a counter offer range, e.g., 10%, 20% or the like, is used to define a price break range. Thus, the highest price break value defines the lower boundary value and is multiplied by the counter offer range percentage to automatically calculate an upper boundary value. For example, if the highest price break value is $10.00 and the counter offer range percentage is 20%, then the upper boundary value would be $12.00 (i.e., 20% larger than $10.00). The counter offer would then be calculated based on the difference between the upper boundary (i.e., $12.00) and the lower boundary value ($10.00), such difference being $2.00. The difference would be multiplied by a random number generated by the server/processor and the resulting product would be added to the lower boundary value to establish a counter offer value which is presented/communicated to the buyer for the number of units requested. The foregoing counter-offer pricing modality is referred to herein as a “boundary-based pricing modality.”

3. As an additional option to the buyer, if #1 or #2 are not acceptable to the buyer, option #3 simply allows the buyer to buy the unit immediately for a fixed price set by the seller, i.e., within the predetermined criteria. According to exemplary embodiments of the present disclosure, this “Buy Now” feature is advantageously part of every offer/counter offer.

Of note, exemplary embodiments of the present disclosure may advantageously permit sellers to choose from among different counter-offer pricing modalities. Thus, for example, a potential seller may choose from: (i) a first counter-offer pricing modality wherein counter-offer(s) are calculated using a counter offer range percentage for all price break values, and (ii) a second counter-offer pricing modality wherein counter-offer(s) are calculated using upper/lower boundaries defined by adjacent price break values (for all price break values except the highest price break value), i.e., a “boundary-based pricing modality.” In addition, according to the present disclosure a seller may be provided with an opportunity to select or define pre-set counteroffer price(s), i.e., non-variable counteroffer price(s) that would be communicated to-a potential buyer in response to a non-acceptable offer. This non-variable counter-offer pricing modality would be offered as an adjunct to at least one of the other pricing modalities set forth herein according to the present disclosure.

A seller may select from among counter offer pricing modalities through entry of a desired selection at an interactive website and communication of such selection across a network, as is known to persons skilled in the art. Alternatively, a default counter offer pricing modality may be associated with an implementation of the disclosed system/method, such default modality being subject to change by a seller, e.g., based on a web-based selection by such seller.

As discussed above with reference to other exemplary embodiments of the present disclosure, a potential buyer of a product or service can only make an offer at predetermined intervals set by the buyer, i.e. once every twenty four (24) hours, once every forty eight (48) hours, once during the life of the offer, or any other interval the seller chooses.

According to the exemplary “boundary-based pricing modality” embodiment described above, the seller of a product or service is generally provided with the ability to set the following variables/parameters which initialize the disclosed system/method for a given product or service.

1. Price breaks and quantities acceptable for each price break:

These price breaks may also be represented in a starting cost and percentage increments which will produce fixed price breaks from this data.

2. The “wait period” duration, which the buyer has to wait to make a repeated/follow-up offer on the same product/service:

This can be any duration, but common values will be in the twenty four (24) hour to life of the offer range. The system may advantageously check several aspects of a buyer's personal data to verify and/or determine if he/she has already made an offer within the predefined repeat offer duration period.

3. The counter offer range which is used to calculate the counter offer made by the system for the highest price break value:

The counter offer range may be from 0 to infinity, although more common or preferred values will be in the 0.05 (5%) to 0.2 (20%) range.

4. The quantity available for sale, i.e., for which potential buyers may submit offers according to the disclosed system/method:

This quantity is automatically reduced for each offer accepted and/or purchase made.

5. The “Buy Now” price which the buyer can accept at any time:

The Buy Now price is generally included in the predetermined criteria by the seller.

The following table illustrates an exemplary relationship between fixed price and # of unit breaks which may be set by the seller in connection with implementation of the disclosed “boundary-based pricing modality,” i.e., within the predetermined criteria. According to the present disclosure, there is no limit to the number of price breaks that may be set or defined within the predetermined criteria.

TABLE 3

| Price Break | # units |
|---|---|
| 5.00 | 12 |
| 6.00 | 8 |
| 7.00 | 6 |
| 8.00 | 4 |
| 9.00 | 2 |
| 10.00 | 1 |

Additional information that may be advantageously included in the predetermined criteria, i.e., beyond the type of information set forth in Table 3, include:

The counter offer range (for use with highest price break value, i.e., $10.00): 0.20

The wait period duration for repeat offers: 24 hours # of units Available—100 units

Buy Now Price: $19.99

According to the present disclosure, price breaks may also be determined by a starting cost and percentage breaks. For example, the following exemplary percentages may be used, which equate to the following price break chart (Starting Cost: $5.00):

TABLE 4

| Percentage | Creates this Price Break | # units (set by seller) |
|---|---|---|
| 0 | 5.00 | 12 |
| .2 ($5.00 × 1.2) | 6.00 | 8 |
| .3 ($5.00 × 1.3) | 6.50 | 6 |
| .4 ($5.00 × 1.4) | 7.00 | 4 |
| .5 ($5.00 × 1.5) | 7.50 | 2 |
| .6 ($5.00 × 1.6) | 8.00 | 1 |

The counter offer for highest price break value, duration, the # of units available, and Buy Now price may also be set or predefined as part of the predetermined criteria, as discussed above.

The present disclosure thus provides a unique and advantageous system/method for automating the offer/counter offer process, i.e., the negotiation process. The disclosed system/method may be implemented on a computer network and may be used for the sale of products and/or services. The present disclosure is particularly applicable to the sale of relatively low cost fungible products or services, such as housewares and other items mass-produced items, although the system/method may be used to advantage in virtually any sales context. Although the disclosed system/method has been described with reference to exemplary embodiments, the disclosure is not to be limited to such exemplary embodiments. Rather, the disclosed system/method is susceptible a wide range of applications and variations, without departing from the spirit and scope of the presently disclosed and claimed invention.

1. A system for implementing an automated negotiation process, comprising:
a processor that is adapted to communicate with a network, said processor further communicating with computer storage and being adapted to run a program that is maintained within said storage, said program adapted to:
i. automatically assess an offer to purchase a good or service received from a user of the system across said network against predefined acceptance criteria stored in said computer storage,
ii. automatically generate one or more counter offers based on predetermined criteria stored in said computer storage, and
iii. automatically transmit said one or more counter offers across said network to said system user;
wherein said offer to purchase a good or service includes a quantity value, and wherein said generation of one or more counter offers includes the steps of:
a. identifying a price break value for said quantity value from said predefined acceptance criteria;
b. establishing a price break range based on said price break value;
c. calculating one or more counter offers based, at least in part, on a product of said price break range and a number randomly generated by said processor.

2. A system according to claim 1, wherein said predetermined criteria include at least two modalities for calculating said one or more counter offers.

3. A system according to claim 1, wherein said predetermined criteria include a buy-now price for said good or service.

4. A system according to claim 1, wherein said one or more counter offers calculated by said processor include one or more combinations of price and quantity.

5. A system according to claim 1, wherein said predetermined criteria include a formula for calculating said randomly generated number.

6. A system according to claim 5, wherein said randomly generated number results in a different counter offer being generated in response to the same offer.

7. A system according to claim 1, wherein said program is adapted to generate and transmit said one or more counter offers in real time.

8. A system according to claim 1, wherein said program is automatically run by said processor without human intervention.

9. A system according to claim 1, wherein said computer storage contains information related to the quantity of goods or services available for purchase.

10. A system according to claim 9, wherein said information contained in said computer storage is automatically updated to reflect changes to the quantity of goods or services available for purchase.

11. A system according to claim 1, wherein said price break range is established based on either (i) a counter offer range included within said predefined acceptance criteria, (ii) a difference between price break values for different quantities of goods or services, or (iii) a combination thereof.

12. A system according to claim 11, wherein the method for establishing the price break range is selectable by a system user.

13. A method for conducting a computer-based negotiation, comprising:
i. receiving an offer from a first location across a network at a processor;
ii. automatically assessing the offer against predefined acceptance criteria;
iii. in the event the offer does not satisfy the predefined acceptance criteria, automatically generating one or more counter offers;
iv. automatically transmitting said one or more counter offers across said network to said first location;
wherein said offer includes a quantity value, and wherein said generation of one or more counter offers includes the steps of:
a. identifying a price break value for said quantity value from said predefined acceptance criteria;
b. establishing a price break range based on said price break value;
c. calculating one or more counter offers based, at least in part, on a product of said price break range and a number randomly generated by said processor.

14. The method of claim 13, wherein said predetermined criteria include a formula for calculating said randomly generated number.

15. The method of claim 13, wherein said one or more counter offers includes one or more combinations of quantity and price.

16. The method of claim 13, wherein said one or more counter offers includes a buy-now option.

17. The method of claim 13, further comprising:
v. transmitting a wait period based on said predetermined criteria.

18. The method of claim 13, wherein said price break range is established based on either (i) a counter offer range included within said predefined acceptance criteria, (ii) a difference between price break values for different quantities of goods or services, or (iii) a combination thereof.

19. A method of claim 19, wherein the method for establishing the price break range is selectable by a system user.
